(19) United States
(12) Patent Application Publication
(10) Pub. No.: US 2025/0232417 A1
(43) Pub. Date: Jul. 17, 2025

(54) DEEP LEARNING-BASED MEDICAL IMAGE MOTION ARTIFACT CORRECTION

(71) Applicant: Mayo Foundation for Medical Education and Research, Rochester, MN (US)

(72) Inventors: Hao Gong, Rochester, MN (US); Shuai Leng, Rochester, MN (US); Joel G. Fletcher, Oronoco, MN (US); Cynthia H. McCollough, Byron, MN (US)

(21) Appl. No.: 18/849,016

(22) PCT Filed: Mar. 21, 2023
(86) PCT No.: PCT/US2023/064787

§ 371 Date: Sep. 20, 2024

Related U.S. Application Data
(60) Provisional application No. 63/321,881, filed on Mar. 21, 2022.

(51) Int. Cl. G06T 5/73; G06T 5/50; G06T 5/60

(52) U.S. Cl. CPC G06T 5/73; G06T 5/50; G06T 5/60; G06T 2207/10081; G06T 2207/20012; G06T 2207/20081; G06T 2207/20084; G06T 2207/20201; G06T 2207/30048

(57) ABSTRACT

Systems and methods for performing motion artifact correction in medical images. One method includes receiving, with an electronic processor, a medical image associated with a patient, the medical image including at least one motion artifact. The method also includes applying, with the electronic processor, a model developed using machine learning to the medical image for correcting motion artifacts, the model including at least one of a spatial transformer network and an attention mechanism network. The method also includes generating, with the electronic processor, a new version of the medical image, where the new version of the medical image at least partially corrects the at least one motion artifact.

### CROSS-REFERENCE TO RELATED APPLICATIONS

This application claims the benefit of U.S. Provisional Patent Application Ser. No. 63/321,881, filed on Mar. 21, 2022, and entitled “Deep Learning-Based Medical Image Motion Artifact Correction,” which is herein incorporated by reference in its entirety.

### STATEMENT REGARDING FEDERALLY SPONSORED RESEARCH

This invention was made with government support under EB028590 awarded by the National Institutes of Health. The government has certain rights in the invention.

### BACKGROUND

Computed Tomography (CT) is a widely used imaging modality helping diagnosis and treatment of various diseases (e.g., cardiovascular diseases), resulting in over 80 million exams performed annually in US. Cardiac CT, e.g. coronary CTA, is a commonly performed exam for patients with suspected coronary artery disease. A major challenge in cardiac CT is the intrinsic motion of the heart, which requires high temporal resolution and electrocardiogram (ECG) gating. Motion artifacts are commonly seen in cardiac CT, which hampers accurate delineation of key anatomic (e.g., coronary lumen) and pathological features (e.g., stenosis), and, ultimately, may sacrifice the diagnosis. This is mainly due to the limited temporal resolution offered by current CT systems. In CT imaging, temporal resolution is primarily determined by data acquisition time, and, more specifically, gantry rotation time. However, gantry rotation of CT systems has already reached the level close to mechanical limit and it is extremely challenging to make the gantry rotate much faster.

Another current CT system includes a dual-source CT (DSCT) technique that uses two data acquisition systems to improve temporal resolution by a factor of two. Although the DSCT may improve temporal resolution, the availability of DSCT is very limited compared to that of standard single-source CT (SSCT). Additionally, DSCT still suffers from motion artifacts for patients with a high heartbeat rate or irregular heartbeats, which may also benefit from further temporal resolution improvement.

Therefore, there is a need to improve temporal resolution of CT, including but not limited to both SSCT and DSCT, for the purpose of improving the quality of cardiac CT exams.

### SUMMARY OF THE DISCLOSURE

As noted above, motion artifact is a major challenge in cardiac CT. Conventional motion correction techniques are limited on patients with high or irregular heart rate due to simplified modeling of CT systems and cardiac motion. Emerging deep learning based cardiac motion correction techniques have demonstrated the potential of further quality improvement. Yet, many methods require CT projection data or advanced motion simulation tools that are not readily available.

To solve these and other problems, the embodiments described herein provide systems and methods for motion correction. The embodiments described herein improve image quality of cardiac CT exams, including, e.g., improved temporal resolution and reduced motion artifacts. Embodiments described herein provide a deep convolutional neural network (CNN) integrated with customized attention and spatial transformer techniques. Embodiments described herein may be implemented directly with CT images, without the need of projection/raw data or any proprietary information. Accordingly, embodiments described herein may be implemented with any scanner vendors and models, including photon-counting-detector (PCD) CT. For example, embodiments described herein enable the full potential PCD-CT to be realized, providing high temporal resolution, high spatial resolution, and multi-energy CT for cardiac imaging.

Accordingly, embodiments described herein provide systems and methods for deep learning-based medical image motion artifact correction. One embodiment provides a system for medical image motion artifact correction. The system includes an electronic processor configured to receive a medical image associated with a patient, the medical image including at least one motion artifact. The electronic processor is also configured to apply a model developed using machine learning to the medical image for correcting motion artifacts, the model including at least one of a spatial transformer network and an attention mechanism network. The electronic processor is also configured to generate a new version of the medical image, wherein the new version of the medical image at least partially corrects the at least one motion artifact.

Another embodiment provides a method for medical image motion artifact correction. The method includes receiving, with an electronic processor, a medical image associated with a patient, the medical image including at least one motion artifact. The method also includes applying, with the electronic processor, a model developed using machine learning to the medical image for correcting motion artifacts, the model including at least one of a spatial transformer network and an attention mechanism network. The method also includes generating, with the electronic processor, a new version of the medical image, wherein the new version of the medical image at least partially corrects the at least one motion artifact.

The foregoing and other aspects and advantages of the present disclosure will appear from the following description. In the description, reference is made to the accompanying drawings that form a part hereof, and in which there is shown by way of illustration a preferred embodiment. This embodiment does not necessarily represent the full scope of the invention, however, and reference is therefore made to the claims and herein for interpreting the scope of the invention.

### BRIEF DESCRIPTION OF THE DRAWINGS

FIG. 1 schematically illustrates a system for medical image motion artifact correction according to some embodiments.

FIG. 2 schematically illustrates a server included in the system of FIG. 1 according to some embodiments.

FIG. 3 is a flowchart illustrating a method for medical image motion artifact correction performed by the system of FIG. 1 according to some embodiments.

FIG. 4 schematically illustrates an example of a deep convolutional neural network based motion correction (CNN-MC) model according to some embodiments.

FIGS. 5A-5B schematically illustrates a spatial transformer network included in the CNN-MC model of FIG. 4 according to some embodiments.

FIGS. 6A-6B schematically illustrates an attention mechanism network included in the CNN-MC model of FIG. 4 according to some embodiments.

FIG. 7 schematically illustrates a hybrid structure of the CNN-MC model of FIG. 4 that incorporates the spatial transformer network of FIG. 5 and the attention mechanism network of FIG. 6 according to some embodiments.

FIG. 8 schematically illustrates a pseudo three-dimensional CNN structure of the CNN-MC model of FIG. 4 according to some embodiments.

FIG. 9 is a table illustrating reconstruction parameters according to some embodiments.

FIG. 10A illustrates an array of images of right coronary arteries for two randomly-selected test cases, before and after motion correction, according to some embodiments.

FIGS. 10B-10C are graphs illustrating example structural similarity index (SSIM) calculated at region-of-interest (ROI) along major coronary arteries with respect to the two randomly-selected test cases of FIG. 10A according to some embodiments.

FIG. 11 illustrates example reformatted images of a left anterior descending artery from one randomly-selected test case, before and after motion correction, according to some embodiments.

### DETAILED DESCRIPTION

One or more embodiments are described and illustrated in the following description and accompanying drawings. These embodiments are not limited to the specific details provided herein and may be modified in various ways. Furthermore, other embodiments may exist that are not described herein. Also, the functionality described herein as being performed by one component may be performed by multiple components in a distributed manner. Likewise, functionality performed by multiple components may be consolidated and performed by a single component. Similarly, a component described as performing particular functionality may also perform additional functionality not described herein. For example, a device or structure that is “configured” in a certain way is configured in at least that way, but may also be configured in ways that are not listed. Furthermore, some embodiments described herein may include one or more electronic processors configured to perform the described functionality by executing instructions stored in non-transitory, computer-readable medium. Similarly, embodiments described herein may be implemented as non-transitory, computer-readable medium storing instructions executable by one or more electronic processors to perform the described functionality. As used in the present application, “non-transitory, computer readable medium” comprises all computer-readable media but does not consist of a transitory, propagating signal. Accordingly, non-transitory computer-readable medium may include, for example, a hard disk, a CD-ROM, an optical storage device, a magnetic storage device, a ROM (Read Only Memory), a RAM (Random Access Memory), register memory, a processor cache, or any combination thereof.

In addition, the phraseology and terminology used herein is for the purpose of description and should not be regarded as limiting. For example, the use of “including,” “containing,” “comprising,” “having,” and variations thereof herein is meant to encompass the items listed thereafter and equivalents thereof as well as additional items. The terms “connected” and “coupled” are used broadly and encompass both direct and indirect connecting and coupling. Further, “connected” and “coupled” are not restricted to physical or mechanical connections or couplings and can include electrical connections or couplings, whether direct or indirect. In addition, electronic communications and notifications may be performed using wired connections, wireless connections, or a combination thereof and may be transmitted directly or through one or more intermediary devices over various types of networks, communication channels, and connections. Moreover, relational terms such as first and second, top and bottom, and the like may be used herein solely to distinguish one entity or action from another entity or action without necessarily requiring or implying any actual such relationship or order between such entities or actions.

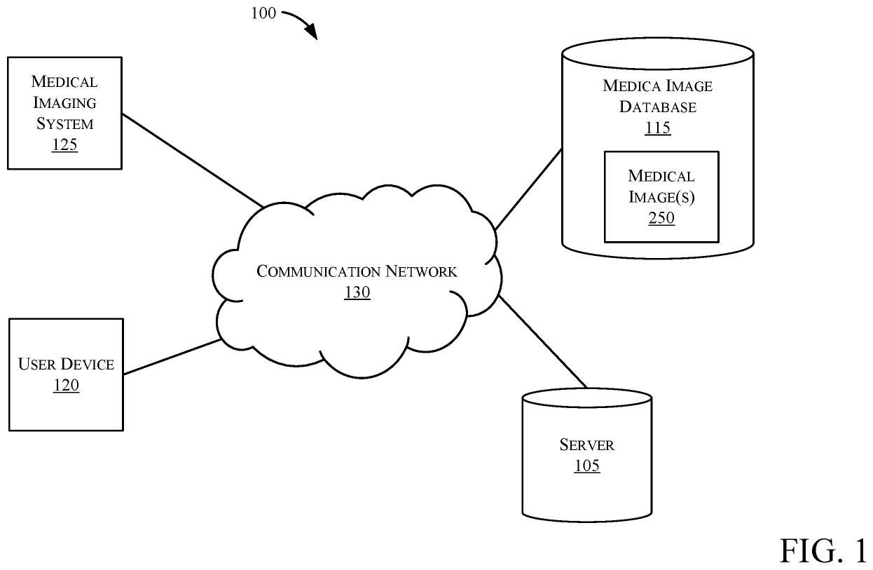

FIG. 1 schematically illustrates a system 100 for medical image motion artifact correction according to some embodiments. The system 100 includes a server 105, a medical image database 115, a user device 120, and a medical imaging system 125. In some embodiments, the system 100 includes fewer, additional, or different components than illustrated in FIG. 1. For example, the system 100 may include multiple servers 105, multiple medical image databases 115, multiple user devices 120, multiple medical imaging system 125, or a combination thereof. Also, in some embodiments, the medical image database 115 may be included in the server 105 and one or both of the medical image database 115 and the server 105 may be distributed among multiple databases or servers.

The server 105, the medical image database 115, the user device 120, and the medical imaging system 125 communicate over one or more wired or wireless communication networks 130. Portions of the communication networks 130 may be implemented using a wide area network, such as the Internet, a local area network, such as Bluetooth™ network or Wi-Fi, and combinations or derivatives thereof. In some embodiments, additional communication networks may be used to allow one or more components of the system 100 to communicate. Also, in some embodiments, components of the system 100 may communicate directly as compared to through a communication network 130 and, in some embodiments, the components of the system 100 may communicate through one or more intermediary devices not shown in FIG. 1.

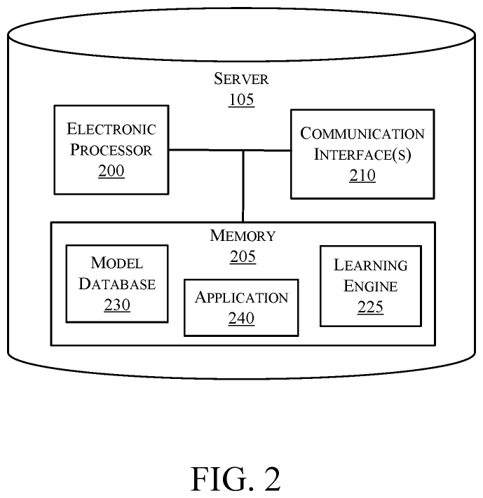

The server 105 may include a computing device, such as a server, a database, or the like. As illustrated in FIG. 2, the server 105 includes an electronic processor 200, a memory 205, and a communication interface 210. The electronic processor 200, the memory 205, and the communication interface 210 communicate through wired connections and/or wirelessly, over one or more communication lines or buses, or a combination thereof. The server 105 may include additional components than those illustrated in FIG. 2 in various configurations. For example, the server 105 may also include one or more human machine interfaces, such as a keyboard, keypad, mouse, joystick, touchscreen, display device, printer, microphone, speaker, and the like, that receive input from a user, provide output to a user, or a combination thereof. The server 105 may also perform additional functionality other than the functionality described herein. Also, the functionality described herein as being performed by the server 105 may be distributed among multiple servers or devices (for example, as part of a cloud service or cloud-computing environment), may be performed by one or more user devices 120, or a combination thereof.

The communication interface 210 allows the server 105 to communicate with devices external to the server 105. For example, as illustrated in FIG. 1, the server 105 may communicate with the medical image database 115, the user device 120, the medical imaging system 125, or a combination thereof through the communication interface 210. The communication interface 210 may include a port for receiving a wired connection to an external device (for example, a universal serial bus (“USB”) cable and the like), a transceiver for establishing a wireless connection to an external device (for example, over one or more communication networks 130, such as the Internet, local area network (“LAN”), a wide area network (“WAN”), and the like), or a combination thereof.

The electronic processor 200 is configured to access and execute computer-readable instructions (“software”) stored in the memory 205. The software may include firmware, one or more applications, program data, filters, rules, one or more program modules, and other executable instructions. For example, the software may include instructions and associated data for performing a set of functions, including the methods described herein.

For example, as illustrated in FIG. 2, the memory 205 may store a learning engine 225 and a model database 230. In some embodiments, the learning engine 225 develops one or more motion artifact correction models using one or more machine learning functions. Machine learning functions are generally functions that allow a computer application to learn without being explicitly programmed. In particular, the learning engine 225 is configured to develop an algorithm or model based on training data. For example, to perform supervised learning, the training data includes example inputs and corresponding desired (for example, actual) outputs, and the learning engine progressively develops a model (for example, a classification model) that maps inputs to the outputs included in the training data. As a non-limiting example, training data may include paired images, such as images acquired with slower temporal resolution (e.g., 140 ms images, which may suffer from severe motion artifacts) being paired with images acquired with higher temporal resolution (e.g., 75 ms images, with fewer motion artifacts than the slower temporal resolution images). In this example, the slower temporal resolution images can be the input and the higher temporal resolution images can be the paired labels. Machine learning performed by the learning engine 225 may be performed using various types of methods and mechanisms including but not limited to decision tree learning, association rule learning, artificial neural networks, inductive logic programming, support vector machines, clustering, Bayesian networks, reinforcement learning, representation learning, similarity and metric learning, sparse dictionary learning, and genetic algorithms. These approaches allow the learning engine 225 to ingest, parse, and understand data and progressively refine models for data analytics.

Motion artifact correction models generated by the learning engine 225 are stored in the model database 230. As illustrated in FIG. 2, the model database 230 is included in the memory 205 of the server 105. However, in some embodiments, the model database 230 is included in a separate device accessible by the server 105 (included in the server 105 or external to the server 105).

As also illustrated in FIG. 2, the memory 205 includes a deep learning-based motion artifact correction application 240 (referred to herein as “the application 240”). The application 240 is a software application executable by the electronic processor 200. As described in more detail below, the electronic processor 200 executes the application 240 to perform motion artifact correction on one or more medical images, such as CT images, such that the one or more medical images have an improved temporal resolution, reduced motion artifacts, and the like. For example, in some embodiments, the application 240 accesses a medical image and performs motion artifact correction on the medical image using one or more models stored in the model database 230, as described in greater detail below.

Returning to FIG. 1, the medical imaging system 125 generates medical images. For example, the medical imaging system 125 may include a CT machine configured to generate CT images. However, in some embodiments, the medical imaging system 125 may be another type of imaging modality, such as, e.g., an MRI machine, an X-ray machine, an ultrasound machine, a PET machine, nuclear imaging machine, and the like. In some embodiments, the medical imaging system 125 generates medical images and forwards the medical images to the server 105. Alternatively or in addition, the medical imaging system 125 forwards the medical images to the medical image database 115 for storage. In other embodiments, the medical imaging system 125 may locally store generated medical images. In still other embodiments, the medical imaging system 125 may transmit generated medical images to one or more image repositories for storage, such as the medical image database 115. In some embodiments, one or more intermediary devices may handle images generated by the medical imaging system 125. For example, images generated by the medical imaging system 125 may be transmitted to a medical image ordering system (including, for example, information about each medical procedure), a picture archiving and communications system (PACS), a radiology information system (RIS), an electronic medical record (EMR), a hospital information system (HIS), and the like.

The medical image database 115 may include a computing device, such as a server, a database, or the like. As illustrated in FIG. 1, the medical image database 115 stores a plurality of medical images 250 (referred to herein collectively as “the medical images 250” and individually as “a medical image 250”). In some embodiments, the medical image database 115 receives the medical images 250 from the medical imaging system 125 via the communication network 130. A medical image 250 may also be referred to herein as medical image data. A medical image 250 may include, for example, a medical image generated by a CT imaging system. As one example, a medical image 250 may be a cardiac CT (e.g., a coronary CTA). Alternatively or in addition, a medical image 250 may be associated with another type of imaging modality, such as an MRI image, an ultrasound image, and the like. In some embodiments, each medical image 250 may be associated with a temporal resolution (e.g., a temporal resolution characteristic or parameter). As one example, a medical image 250 associated with a temporal resolution of approximately 140 ms may be considered as having a slow temporal resolution. As another example, a medical image 250 associated with a temporal resolution of approximately 75 ms may be considered as having a fast temporal resolution. In some embodiments, a temporal resolution of a medical image 250 may be included as metadata for the medical image 250.

In some embodiments, the medical images 250 stored in the medical image database 115 include training data used by the learning engine 225. For example, in some embodiments, the training data includes one or more CT images from one cardiac phase or consecutive cardiac phases (e.g., 65-80% R-R interval) with slow temporal resolution (e.g., 140 ms) (as input data) and a counterpart CT image from one quiescent phase (e.g., 75% R-R interval) with fast temporal resolution (e.g., 75 ms) medical images 250 (as labels). Accordingly, embodiments described herein may be implemented directly with medical images 250 (e.g., CT images), without projection or raw data. In some embodiments, before being used as training data, the medical images 250 may be filtered. For example, the medical images 250 may be filtered to identify subsets or groupings of medical images 250 based on temporal resolution, phases (e.g., consecutive cardiac phases), or the like.

As noted above, in some embodiments, the medical image database 115 is combined with the server 105. Alternatively or in addition, the medical images 250 may be stored within a plurality of databases, such as within a cloud service. Furthermore, in some embodiments, the medical images 250 may be stored in a memory of the user device 120. In some embodiments, the medical image database 115 may be associated with one or more entities, such as a particular healthcare provider, a health collaborative, a health maintenance organization (HMOs), or the like. Although not illustrated in FIG. 1, the medical image database 115 may include components similar to the server 105, such as an electronic processor, a memory, a communication interface and the like. For example, the medical image database 115 may include a communication interface configured to communicate (for example, receive data and transmit data) over the communication network 130.

The user device 120 may also include a computing device, such as a desktop computer, a laptop computer, a tablet computer, a terminal, a smart telephone, a smart television, a smart wearable, or another suitable computing device that interfaces with a user. Although not illustrated in FIG. 1, the user device 120 may include similar components as the server 105, such as electronic processor (e.g., a microprocessor, an application-specific integrated circuit (ASIC), or another suitable electronic device), a memory (e.g., a non-transitory, computer-readable storage medium), a communication interface, such as a transceiver, for communicating over the communication network 130 and, optionally, one or more additional communication networks or connections, and one or more human machine interfaces. For example, to communicate with the server 105, the user device 120 may store a browser application or a dedicated software application executable by an electronic processor. In some embodiments, the user device 120 includes additional, fewer, or different components than the server 105. For example, in some embodiments, the user device 120 includes a display device, such as a screen, monitor, or touchscreen. In some embodiments, the user device 120 also includes an input mechanism, such as a keyboard or keypad, one or more buttons, a microphone, or the like. In embodiments where the user device 120 includes a touchscreen, the touchscreen may function as an input device but, in some embodiments, the user device 120 also includes one or more additional input devices.

The user device 120 may include other software applications. Example software applications may enable a user to display an EMR, access a PACS or another system or data storage device, or the like. The system 100 is described herein as providing a motion artifact correction service through the server 105. However, in other embodiments, the functionality described herein as being performed by the server 105 may be locally performed by the user device 120. For example, in some embodiments, the user device 120 may store the learning engine 225, the model database 230, the application 240, or a combination thereof.

The user device 120 may be used by an end user to generate and interact with medical images, including enhanced or improved medical images. As one example, a user may use the user device 120 to access a CT image and perform a motion artifact correction technique on the CT image (via, e.g., the application 240), such that the CT image has an improved temporal resolution and reduced motion artifacts. As another example, a user may use the user device 120 to interact with or view an enhanced medical image (e.g., a CT image with improved temporal resolution and reduced motion artifacts) for diagnostic and reporting purposes.

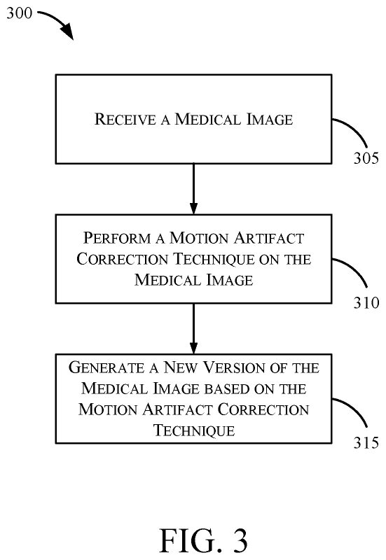

FIG. 3 is a flowchart illustrating a method 300 for performing medical image motion artifact correction performed by the system 100 according to some embodiments. The method 300 is described as being performed by the server 105 and, in particular, the application 240 as executed by the electronic processor 200. However, as noted above, the functionality described with respect to the method 300 may be performed by other devices, such as the user device 120, or distributed among a plurality of devices, such as a plurality of servers included in a cloud service. Additionally, the method 300 is described as being performed with respect to a CT image (e.g., the medical image 250). However, it should be understood that the method 300 may be performed with respect to other types of medical images, such as MRI images, ultrasound images, or the like.

As illustrated in FIG. 3, the method 300 includes receiving a medical image 250 (at block 305). The medical image 250 may be a CT image, such as a cardiac CT image. In some embodiments, the medical image 250 includes one or more motion artifacts. A motion artifact may be described or represented by a motion artifact characteristic. Accordingly, the medical image 250 may be associated with a motion artifact characteristic describing a motion artifact of the medical image 250. In some embodiments, receiving a medical image 250 may include receiving raw projection data.

The electronic processor 200 may receive the medical image 250 through the communication network 130 from the medical imaging system 125, the user device 120, the medical image database 115, or a combination thereof. As one example, the electronic processor 200 may receive the medical image 250 directly from the medical imaging system 125 after the medical image 250 was generated by the medical imaging system 125 (e.g., immediately after the medical imaging system 125 generates the medical image 250). As another example, the electronic processor 200 may receive the medical image 250 after a predetermined amount of time has elapsed since the medical image 250 was generated by the medical imaging system 125, such as several hours, a day, several days, or the like. Accordingly, in some embodiments, the medical imaging system 125 is configured to automatically transmit the medical image 250 to the server 105 (e.g., the electronic processor 200) for motion artifact correction prior to transmitting the medical image 250 for storage (e.g., locally in a memory of the medical imaging system 125 or remotely in a memory of the user device 120 or the medical image database 115).

In response to receiving the medical image 250 (at block 305), the electronic processor 200 performs a motion artifact correction technique on the medical image 250 (at block 310). The electronic processor 200 may perform the motion artifact correction technique on the medical image 250 by applying a model developed using machine learning to the medical image 250. As noted above, the model database 230 may store one or more models developed by the learning engine 225. Accordingly, the electronic processor 200 may access a model from the model database 230 and apply the model to the medical image 250.

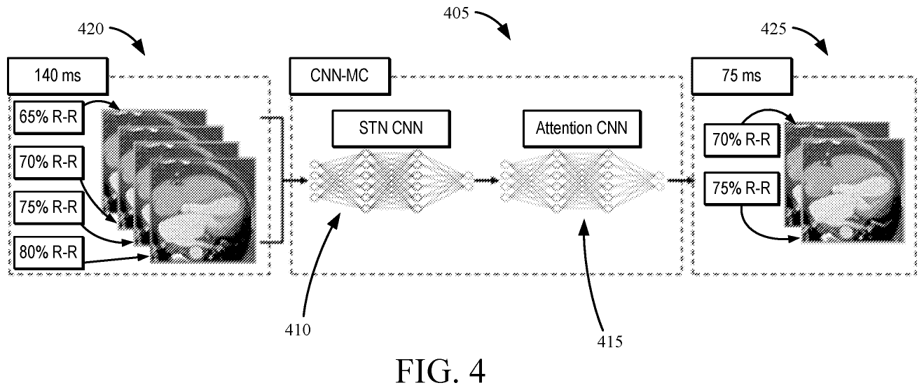

In some embodiments, the model is a neural network, such as, e.g., a convolutional neural network (CNN). For example, the model may be a convolutional neural network configured to compensate cardiac motion artifacts. FIG. 4 schematically illustrates an example of a deep convolutional neural network based motion correction (CNN-MC) model 405 according to some embodiments. The CNN-MC model may be stored in the model database 230 of the server 105 and accessible by the electronic processor 200.

During training of the CNN-MC model 405, the CNN(s) may implicitly learn one or more patterns of motion artifact and consequently correct it. In the illustrated example, the CNN-MC model 405 jointly utilizes the techniques of a spatial transformer (e.g., a spatial transformer network 410) and attention (e.g., an attention mechanism network 415). The attention mechanism network 415 and the spatial transformer network 410 enable the CNN(s) (e.g., the CNN-MC model 405) to focus on the dynamic structure of heart and correct the corresponding motion artifact without using a complicated system model that relies on assumptions of the modes of cardiac motion and physical processes. This enables improvement of the delineation of coronary arteries and, if any, calcifications. Further, the CNN-MC model 405 is vendor agnostic, as it may be fully implemented in the CT image domain.

As illustrated in FIG. 4, a set of medical images 250 (e.g., a set of CT images) with slow temporal resolution (e.g., 140 ms) are obtained at one cardiac phase or several consecutive cardiac phases (e.g., 65% to 80% R-R interval). This set of medical images 250 is represented in FIG. 4 by reference numeral 420. The set of reconstructed medical images 420 are used as the inputs to the CNN-MC, as illustrated in FIG. 4. The corresponding CT images with fast temporal resolution (e.g., 75 ms) are used as the labels in the training of the CNN-MC model 405. The corresponding CT images are represented in FIG. 4 by reference numeral 425. Once the training is completed, the CNN-MC model 405 may be deployed to process new CT images with slow temporal resolution (e.g., as part of block 310 of FIG. 3).

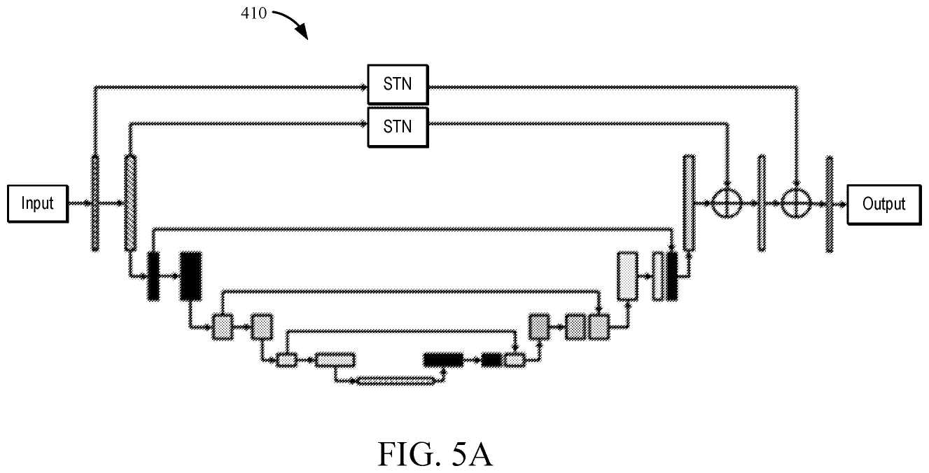

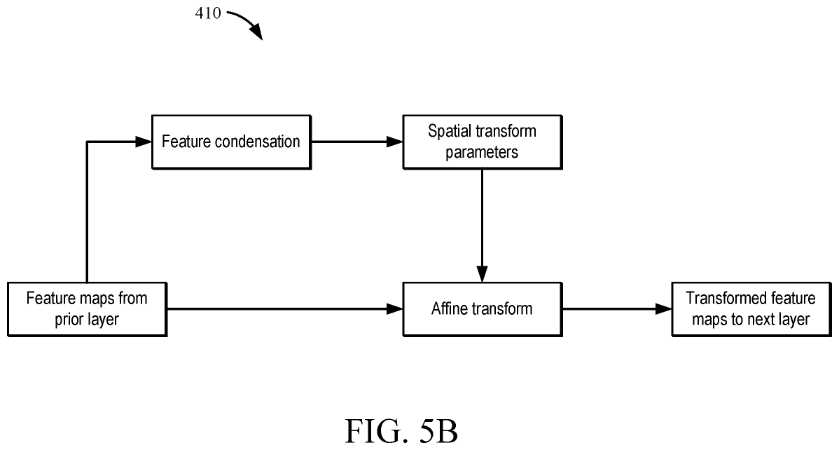

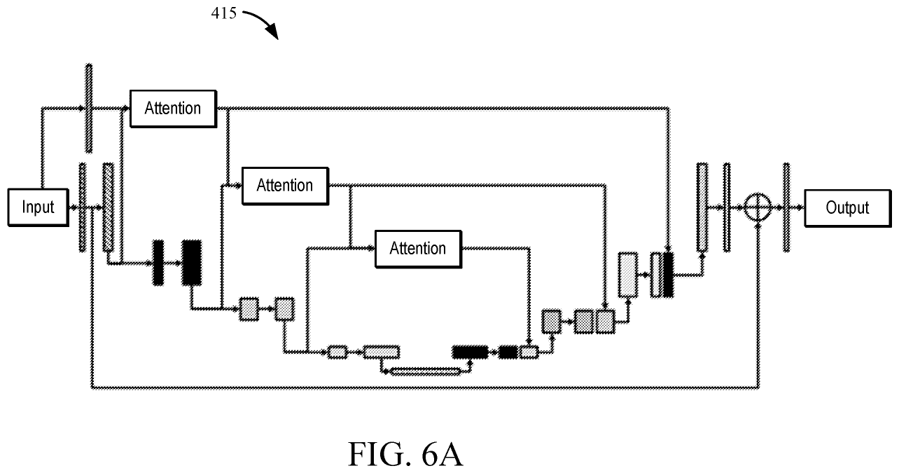

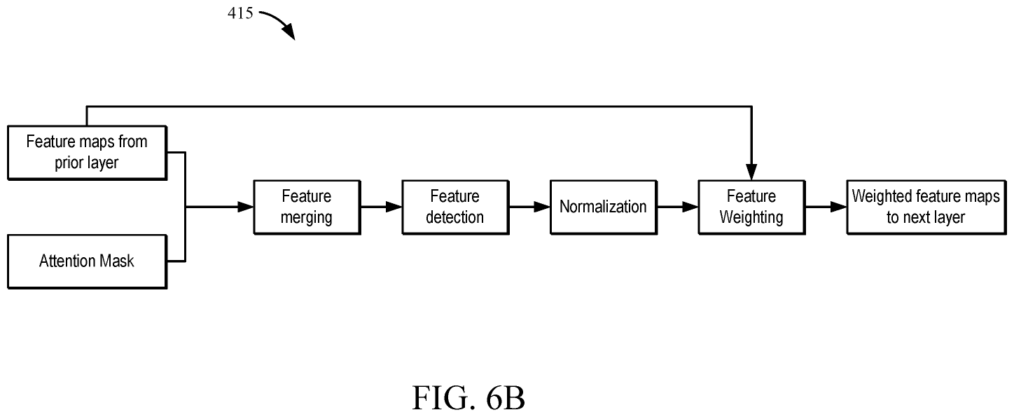

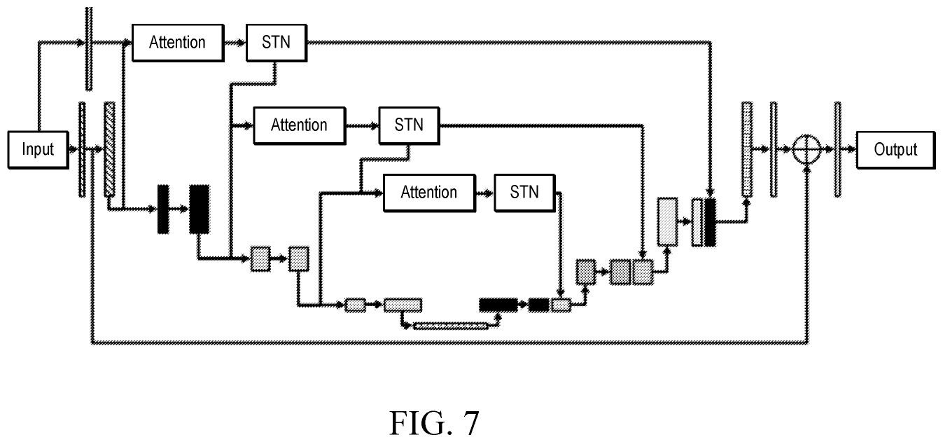

FIGS. 5A-5B schematically illustrates an example of the spatial transformer network 410 according to some embodiments. The spatial transformer network 410 may be a CNN. As illustrated in FIG. 5A-5B, each STN module is a sub-network that implements a spatial transformer technique. In some embodiments, the spatial transformer network 410 enables adaptive affine transformation based on local image features. FIG. 6A schematically illustrates an example of the attention mechanism network 415 according to some embodiments. The attention mechanism network 415 may be a CNN. As illustrated in FIG. 6A, each attention module is a sub-network that implements an attention mechanism technique. In some embodiments, the attention mechanism network 415 enables adaptive focus on important features or parts (e.g., dynamic structure) included in the medical image 250 (e.g., a dynamic structure of a patient's heart). FIG. 6B illustrates a custom attention mechanism or module (e.g., as the attention mechanism network 415) according to some embodiments. As illustrated in FIG. 6B, the custom attention module uses non-local features of attention mask to differentiate task-relevant and task-irrelevant local features of CT images. Detection of task-relevant structure (e.g., dynamic structure in heart) were facilitated by the attention mask derived from multi-phase input images. Task-irrelevant features were suppressed in the weighted feature maps. Alternatively or in addition, in some embodiments, the CNN-MC model 405 implements a hybrid structure, as illustrated in FIG. 7. As illustrated in FIG. 7, the CNN-MC model 405 may include attention modules incorporated with spatial transformer modules. In some embodiments, the base neural network structure can be implemented using standard 2-D convolution (i.e., 2-D CNN) or standard 3-D convolution (i.e., 3-D CNN).

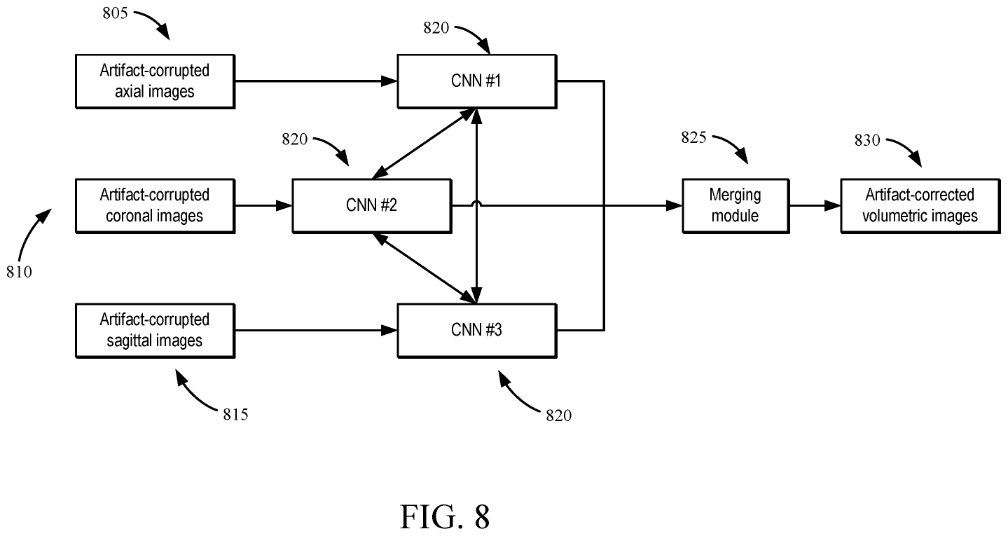

Alternatively or in addition, in some embodiments, the CNN-MC model 405 implements a pseudo 3-D CNN structure, as illustrated in FIG. 8. As illustrated in FIG. 8, one or more axial images 805 (e.g., artifact-corrupted axial images 805), one or more coronal images 810 (e.g., artifact-corrupted coronal images 810), and one or more sagittal images 815 (e.g., artifact-corrupted sagittal images 815) of coronary arteries may be fed into separate sub-networks 820 (represented in FIG. 8 as CNN #1, CNN #2, and CNN #3) to suppress motion artifacts. As illustrated in FIG. 8, the three CNNs 820 are connected to share mutual image information and exploit common image features across different image types (i.e., axial, coronal, and sagittal). The proposed images may be finally merged (e.g., via a merging module 825) to form volumetric images with suppressed motion artifacts (represented in FIG. 8 by reference numeral 830).

In some embodiments, the CNN-MC model 405 may be associated with a customized loss function. When the customized loss function is implemented, the parameters of the CNNs may be optimized. The customized loss function may be

$$L = \frac{1}{N} \sum ( {‖ {f}_{CNN} - {f}_{GT} ‖}_{2}^{2} + \frac{1}{ρ ( ∇ {f}_{CNN} , ∇ {f}_{GT} ) + ∈} + λ {‖ {ϕ}_{n} ( {f}_{CNN} ) - {ϕ}_{n} ( {f}_{GT} ) ‖}_{2}^{2} )$$

The loss function may include a data fidelity term and two regularization terms. The data fidelity term may include, e.g., a mean-square error. The two regularization terms may include, e.g., an image-gradient-correlation and a feature-reconstruction loss. The terms of the loss function may be used to gauge the consistency of CT number, boundary, and high-level image features, respectively.

Alternatively or in addition, in some embodiments, the loss function may be associated with additional regularization terms, as set forth below:

| | | |
|---|---|---|
| Entropy | ${L}_{ent} = - {\sum }_{h} P ( h ) ln P ( h )$ $P ( h ) = \frac{1}{\vert Ω \vert} {\sum }_{{h}_{j} ∈ Ω} K ( {h}_{j} - h )$ $K ( x ) = \frac{1}{\sqrt{2 π}} exp ( - \frac{1}{2} {x}^{2} )$ | P(h) - the probability of a voxel having CT number h inside a region-of-interest Ω in CT image. K (x) - the Parzen- windowing with Gaussian Kernel. |
| Positivity | $\begin{matrix}{L}_{pos} = \\ {\sum }_{{h}_{j} ∈ Ω} ( \{ \begin{matrix}0 & {T}_{lung} \leq {h}_{j} \leq {T}_{fat} \\ {( {h}_{j} - {T}_{fat} )}^{2} & otherwise\end{matrix} )\end{matrix}$ | hⱼ - the jth voxel within region- of-interest Ω T_{fat} - the threshold CT number of fatty tissue in CT image T_{lung} - the threshold CT number of lung tissue in CT image |

Returning to FIG. 3, the electronic processor 200 may then generate a new version of the medical image 250 (e.g., a motion-corrected medical image) based on the motion artifact correction technique (at block 315). As noted above, the motion artifact correction technique may include applying a model developed using machine learning (e.g., the CNN-MC model 405 of FIG. 4). Accordingly, in some embodiments, the electronic processor 200 generates the new version of the medical image 250 based on the application of the model (e.g., the CNN-MC model 405 of FIG. 4). The new version of the medical image 250 may correct one or more motion artifacts included in the medical image 250. Accordingly, the new version of the medical image 250 may provide an improved temporal resolution, reduced motion artifacts, or a combination thereof. In some embodiments, correcting the one or more motion artifacts includes removing a motion artifact (or a portion thereof). The new version of the medical image 250 may be associated with improved delineation, brightness (e.g., signal intensity), structural similarity index (SSIM), or a combination thereof (in comparison to the version of the medical image 250 received at block 305 of FIG. 3, such as an “original version”). As one example, the new version of the medical image 250 may have an improved delineation of coronary arteries, calcifications, or a combination thereof as compared to the original version of the medical image 250.

In some embodiments, the electronic processor 200 transmits the new version of the medical image 250 to a remote device. As one example, the electronic processor 200 may transmit the new version of the medical image 250 to the user device 120 for display to a user of the user device 120 (via, e.g., a display device or other output mechanism of the user device 120). As another example, the electronic processor 200 may transmit the new version of the medical image 250 to a remote device for storage, such as, e.g., the user device 120, the medical image database 115, or another component of the system 100.

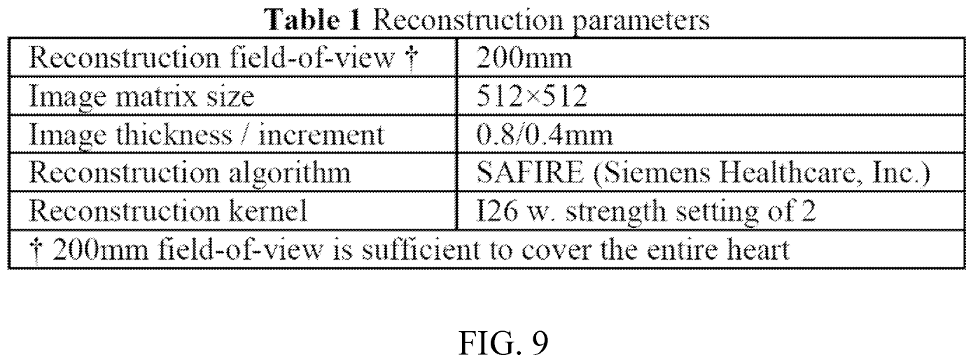

The embodiments described herein were tested on a patient cohort of ECG-gated (retrospective gating) cardiac CT exams (n=40) that were retrospectively collected to create training and testing datasets for the CNN-MC model 405. Each case was originally acquired from a clinical dual-source CT scanner. 26 cases were randomly selected to generate training datasets (e.g., training data used by the learning engine 225 of the server 105). The remaining cases were reserved for validation. CT images corresponding to slow and fast temporal resolution (i.e., 140 ms and 75 ms, respectively) were reconstructed using the same projection data. For slow temporal resolution, CT images were reconstructed across cardiac phases corresponding to 65%, 70%, 75% and 80% R-R interval in ECG. Of note, these images (slow temporal resolution) were equivalent to the CT images acquired from SSCT (denoted as “pseudo SSCT images”). For fast temporal resolution, CT images were reconstructed at the relatively quiescent phase of 75% R-R interval (denoted as “reference images”). The major parameters of image reconstruction are listed in the table illustrated in FIG. 9.

After reconstruction was completed, image patches of coronary arteries were acquired to generate additional training datasets. Centerline of major coronary arteries, including right coronary artery (RCA), left anterior descending artery (LAD), and circumflex artery (CX) was obtained. Finally, image patches (80×80 pixels per patch) centered at these coronary arteries were extracted from axial CT images.

This pilot study involved two experiments. First, the effects of two training-inference strategies on CNN performance were evaluated. Strategy #1 trained the CNN using original 200 mm FOV of the whole heart, and then deployed the CNN to the testing images with 200 mm FOV. Strategy #2 trained the CNN using patches of coronary arteries, and deployed the CNN to testing patches of coronary arteries. In this experiment, only the attention based network (e.g., the attention mechanism network 415) was used for simplicity but without losing generality. In the second experiment, the influence of network structure on CNN performance was investigated, and only strategy #2 was used for simplicity. Besides visual inspection, the CT number accuracy and structural similarity index (SSIM) were also evaluated.

In some embodiments, training is implemented by using patch-based training, where image patches were centered at coronary arteries, using standard augmentation (e.g., rotation, flipping, etc.), and using Adam optimizer with dropout (rate=0.1). In some embodiments, inference included applying cardiac motion correction to testing patches of coronary arteries and implementing Monte Carlo Dropout (e.g., used the averaged CNN outputs as final output percase). With respect to the Monte Carlo Dropout, standard dropout operation (i.e., randomly deactivating neurons) may be turned on in both training and inference. Using Monte Carlo Dropout during inference stage improves the stability of network outputs (i.e., averaging neural network outputs across several iterations of Monte Carlo Dropout). In some embodiments, evaluation includes visual inspection, CT number error (at lumen), structural similarity, or the like.

Before correction, motion artifacts distorted cross-sectional structure of coronary arteries, blurred the edge of vessels, and induced CT number error at iodine-lumen. Both strategies #1 and #2 improved the delineation, brightness (signal intensity), and SSIM of coronary arteries, as illustrated in FIGS. 9A-9C. FIG. 9A illustrates an array of images of right coronary arteries (from two randomly-selected testing cases) before and after motion correction, using training-inference strategies #1 and #2. Each zoomed inset was centered at the vessel. In each inset, the digits above the vessel indicate the mean CT number measured from the lumen. FIGS. 9B-9C illustrate examples of structural similarity index (SSIM) calculated at region-of-interest (ROI; 40×40 pixels per ROI) along major coronary arteries in case #1 (FIG. 9B) and case #2 (FIG. 9C). As illustrated in FIGS. 9A-9C, strategy #1 raised additional vessel displacement at multiple places along the coronary arteries, which largely degraded the corresponding SSIM (i.e., the arrow in FIG. 9C). Strategy #2 demonstrated substantial improvement of CT number accuracy and SSIM compared to strategy #1 (as illustrated in the table below). Therefore, strategy #2 was used in all following evaluations.

| | Strategy #1, | Strategy #2, | Original 140 ms, |
|---|---|---|---|
| | CNN #1 | CNN #1 | 75% R-R |
| CT Number Error | 42.7 ± 50.2 | 31.0 ± 41.3 | 80.6 ± 74.6 |
| SSIM | 0.89 ± 0.10 | 0.91 ± 0.06 | 0.85 ± 0.10 |

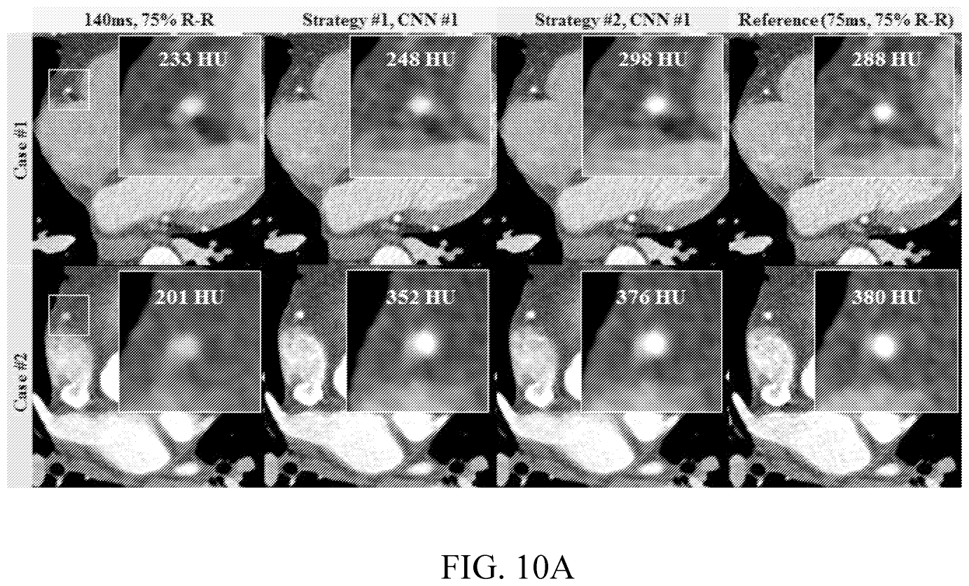

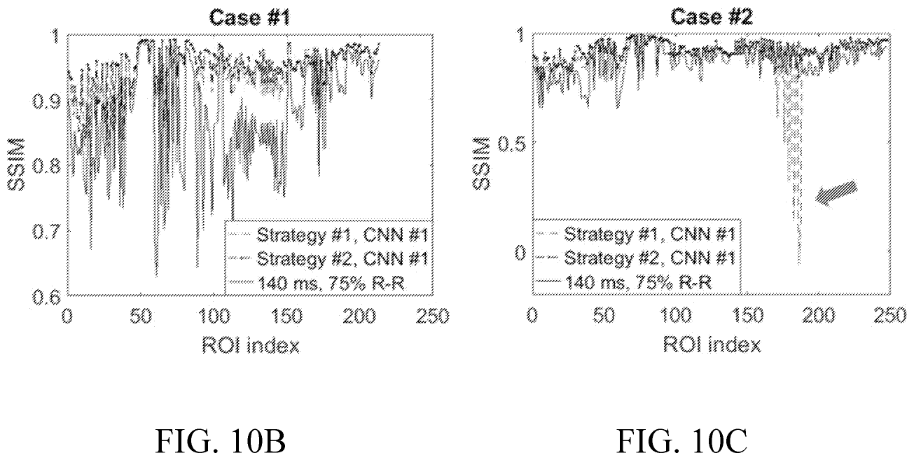

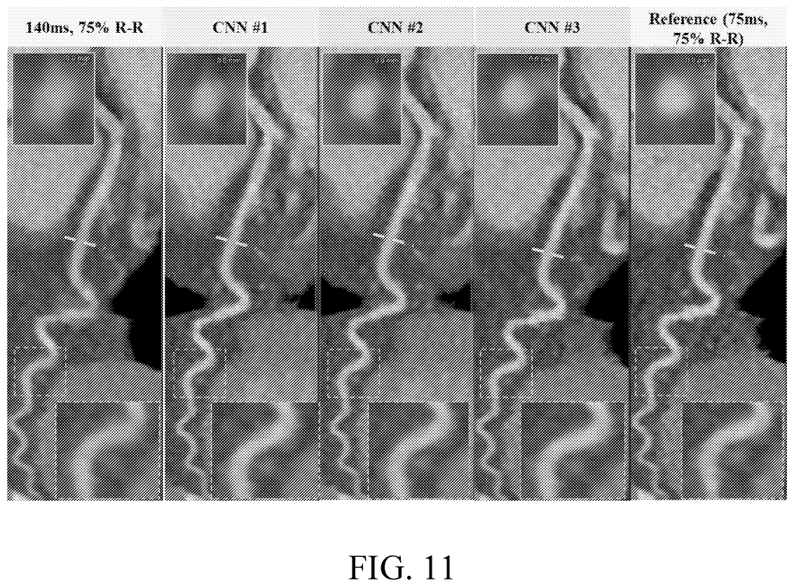

With the same training-inference strategy, CNN #3 (e.g., the hybrid network of FIG. 7) demonstrated relatively better delineation of coronary arteries (as illustrated in FIG. 10) and lower CT number errors (as illustrated in the table below) than the other two. FIG. 10 illustrates examples of reformatted images of LAD from one randomly-selected testing case, before and after motion correction. The upper insets illustrated the cross-sectional images extracted along the dashed lines. The bottom insets illustrated the reformatted vessels extracted from rectangular region-of-interest. Image reformation and extraction was conducted using commercial software. The table below illustrates examples of the mean and standard deviation of CT number error (HU) and SSIM with different CNNs, using the training-inference strategy #2.

| | CNN #1 | CNN #2 | CNN #3 |
|---|---|---|---|
| CT number error | 31.0 ± 41.3 | 30.7 ± 43.7 | 23.4 ± 43.4 |
| SSIM | 0.91 ± 0.06 | 0.91 ± 0.06 | 0.91 ± 0.07 |

The three CNNs yielded comparable SSIM (as illustrated in the table above). The 140 ms SSCT image showed clear broadening of the LAD with blurry boundaries (in both curved reformat and axial images) compared to the reference 75 ms DSCT image.

Accordingly, embodiments described herein provide methods and systems of deep learning-based medical image motion artifact correction, and, more particularly, for cardiac CT images. The embodiments described herein improve SSCT cardiac image quality approaching that of DSCT, by reducing motion artifacts using deep-learning based approaches. As described herein, three deep CNNs with customized attention and STN techniques were developed to directly synthesize DSCT images, using pseudo SSCT images as inputs. The CNNs disclosed herein do not request access to patient raw projection data or advanced cardiac motion simulation tools. In the pilot study, the CNNs improved the delineation, structural accuracy, and CT number accuracy of iodine-enhanced coronary arteries. The embodiments described herein demonstrated the potential of improving image quality in cardiac exams with SSCT.

The present disclosure has described one or more preferred embodiments, and it should be appreciated that many equivalents, alternatives, variations, and modifications, aside from those expressly stated, are possible and within the scope of the invention.

1. A method for performing motion artifact correction in medical images, the method comprising:
receiving, with an electronic processor, a medical image associated with a patient, the medical image including at least one motion artifact;
applying to the medical image, with the electronic processor, a model developed using machine learning for correcting motion artifacts, the model including at least one of a spatial transformer network and an attention mechanism network; and
generating, with the electronic processor, a new version of the medical image as an output by applying the model to the medical image, wherein the new version of the medical image at least partially corrects the at least one motion artifact.

2. The method of claim 1, wherein receiving the medical image includes receiving a computed tomography (CT) medical image.

3. The method of claim 2, wherein the CT medical image is a cardiac CT image.

4. The method of claim 1, wherein receiving the medical image includes receiving a medical image associated with a first motion artifact characteristic, wherein the new version of the medial image is associated with a second motion artifact characteristic different than the first motion artifact characteristic.

5. The method of claim 4, wherein the first motion artifact characteristic and the second motion artifact characteristic are associated with delineation of a feature depicted in the medical image, wherein the second motion artifact characteristic is associated with an improved delineation of the feature in comparison to the first motion artifact characteristic.

6. The method of claim 4, wherein the first motion artifact characteristic and the second motion artifact characteristic are associated with a brightness of the medical image, wherein the second motion artifact characteristic is associated with an improved brightness in comparison to the first motion artifact characteristic.

7. The method of claim 1, wherein applying the model includes applying a model that was developed using machine learning using pseudo single-source CT images.

8. The method of claim 1, wherein applying the model includes applying a model that was developed using machine learning with training data, the training data including a set of medical images from consecutive cardiac phases with a first temporal resolution as inputs and a set of corresponding medical images having a second temporal resolution as labels, wherein the first temporal resolution is different than the second temporal resolution.

9. The method of claim 8, wherein the first temporal resolution is 140 ms.

10. The method of claim 8, wherein the second temporal resolution is 75 ms.

11. The method of claim 1, further comprising transmitting the new version of the medical image to a remote device for display.

12. The method of claim 1, wherein applying the model includes applying a deep convolutional neural network (CNN) including a spatial transformation CNN and an attention mechanism CNN.

13. The method of claim 12, wherein the deep CNN comprises at least one of a two-dimensional CNN structure, a three-dimensional CNN structure, or a pseudo-3D CNN structure.

14. The method of claim 1, wherein applying the model includes applying the spatial transformer network and the attention mechanism network.

15. The method of claim 14, wherein applying the model includes applying the attention mechanism network and applying an output of the attention mechanism network to the spatial transformer network.

16. The method of claim 1, wherein the medical image has a first temporal resolution and the new version of the medical image is representative of a second temporal resolution.

17. The method of claim 16, wherein the first temporal resolution is slower than the second temporal resolution.

18. The method of claim 17, wherein the first temporal resolution is 140 ms and the second temporal resolution is 75 ms.

19. The method of claim 16, wherein the first temporal resolution is 75 ms.

20. A method for reducing motion-induced artifacts in medical images, the method comprising:
receiving, with an electronic processor, a time-series of medical images depicting a heart of a subject, wherein the time-series of medical images is corrupted by motion-induced artifacts;
receiving, with the electronic processor, a hybrid convolutional neural network (CNN) trained on training data to reduce motion-induced artifacts in medical images, wherein the hybrid CNN comprises at least one attention mechanism network connected with at least one spatial transformer network;
inputting the time-series of medical images to the hybrid CNN using the electronic processor, generating an output as an artifact-corrected time-series of medical images in which motion-induced artifacts are reduced relative to the time-series of medical images; and
presenting the artifact-corrected time-series of medical images to a user.

21. The method of claim 20, wherein the at least one attention mechanism network adaptively focuses on dynamic structures of the heart of the subject using non-local features of an attention mask to differentiate task-relevant and task-irrelevant local features in the time-series of medical images.

22. The method of claim 20, wherein the at least one spatial transformer network adaptively applied affine transformation to the time-series of medical images based on local image features in the time-series of medical images.
